(19) United States
(12) Patent Application Publication
(10) Pub. No.: US 2012/0029112 A1
(43) Pub. Date: Feb. 2, 2012

(54) Biopolymer Compositions Having Improved Impact Resistance

(75) Inventors: Kimberly L. Stefanisin, Oak Lawn, IL (US); Stephen Semlow, Palos Park, IL (US); Stephen O'Rourke, Bolingbrook, IL (US); Gary Wentworth, Morris, IL (US)

(73) Assignee: HALLSTAR INNOVATIONS CORP., Chicago, IL (US)

(21) Appl. No.: 12/845,578

(22) Filed: Jul. 28, 2010

(51) Int. Cl. C08K 5/11

(52) U.S. Cl. 523/124

(57) ABSTRACT

The present disclosure is directed to polymer blends comprising a biopolymer and one or more impact modifiers, wherein at least one impact modifier is an ester of formula I:

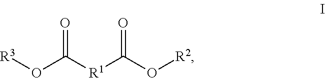

and to methods for increasing the impact resistance of a biopolymer with one or more impact modifiers, wherein at least one impact modifier is a ester of formula I. The polymer blends disclosed herein provide impact resistance, and are useful, for example, in the production of packaging materials, industrial products, durable goods, and the like.

### BACKGROUND

1. Field of the Disclosure

The disclosure relates generally to renewably-sourced and biodegradable polymer blends, and to methods of improving the impact resistance of biopolymers. More specifically, the disclosure relates to polymer blends comprising a biopolymer and an ester impact modifier, and to methods of improving the impact resistance of biopolymers by combining a biopolymer and an ester impact modifier as disclosed herein.

2. Brief Description of Related Technology

Conventional petroleum-based polymers include traditional plastics used in packaging and other consumer product applications. Petroleum-based polymer products, however, have several disadvantages including the accumulation of non-degradable plastics in landfills and the use of non-renewably sourced materials. Biopolymers provide an alternative to petroleum-based polymers. In contrast to petroleum-based polymers, products prepared from biopolymers are biodegradable and/or use materials obtained from renewable natural sources.

While overcoming many of the disadvantages of traditional petroleum-based polymers, biopolymers can suffer from different disadvantages. Many biopolymers are difficult to process and/or demonstrate other undesirable physical properties, such as poor impact resistance. The physical properties of biopolymers can be modified by blending with other materials to obtain biodegradable and/or renewably-sourced polymer materials having more desirable physical properties. The polymer blends disclosed herein provide biopolymers having improved impact resistance, and are useful, for example, in the production of packaging materials, industrial products, durable goods, and the like.

### SUMMARY

One aspect of the disclosure is directed to a polymer blend comprising a biopolymer (e.g., polylactic acid) and one or more impact modifiers, wherein at least one impact modifier is an ester of formula I:

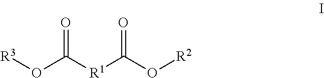

wherein R¹ is a substituted or unsubstituted aliphatic hydrocarbon group having 1 to 10 carbon atoms, and R² and R³ are each a substituted or unsubstituted aliphatic hydrocarbon group having 4 to 14 carbon atoms. In some embodiments, the one or more impact modifiers are present in a total amount of about 5 to about 30 parts by weight per hundred parts by weight of the biopolymer. In some embodiments, the one or more impact modifiers are present in a total amount of about 5 to about 15 parts by weight per hundred parts by weight of the biopolymer.

In some embodiments, two or more impact modifiers are present, for example, two or more esters of formula I. In some embodiments, two or more impact modifiers are present, for example, at least one ester of formula I and at least one polyester. In some embodiments, two or more impact modifiers are present, for example, at least one ester of formula I and at least one acrylic polymer. In some embodiments, the at least one ester of formula I is present in an amount of about 5 to about 15 parts by weight per hundred parts by weight of the biopolymer, and the at least one polyester is present in an amount of about 5 to about 15 parts by weight per hundred parts by weight of the biopolymer. In some embodiments, the polyester comprises a copolymer of an aliphatic diol and an aliphatic diacid, such as a copolymer of 1,2-propanediol and succinic acid, or a copolymer of 1,2-propanediol and succinic acid terminated with decanol. In some embodiments, the polyester comprises a copolymer of an aliphatic diol and an aromatic diacid, such as a copolymer of an aliphatic diol, an aromatic diacid, and an aliphatic diacid, for example, a copolymer of 1,4-butanediol, terephthalate (or terephthalic acid), and adipate (or adipic acid).

Another aspect of the disclosure is directed to a method for increasing the impact resistance of a biopolymer (e.g., polylactic acid) comprising mixing the biopolymer and one or more impact modifiers, wherein at least one impact modifier is a ester of formula I as defined herein. In some embodiments the one or more impact modifiers are present in a total amount of about 5 to about 30 parts by weight per hundred parts by weight of the biopolymer.

Another aspect of the disclosure is directed to a polymer blend comprising a biopolymer (e.g., polylactic acid) and one or more impact modifiers, wherein at least one impact modifier is an ester of formula I

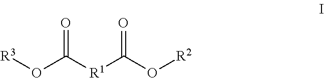

wherein R¹ is selected from the group consisting of —(CH₂)₂— and —(CH₂)₈—; R² and R³ are selected from the group consisting of n-octyl, isooctyl, and 2-ethylhexyl; and the impact modifiers are present in a total amount of about 5 to about 30 parts by weight per hundred parts by weight of the biopolymer. In some embodiments, the impact modifiers are present in a total amount of about 5 to about 15 parts by weight per hundred parts by weight of the biopolymer. In some embodiments, R¹ is —(CH₂)₂—, and R² and R³ are isooctyl. In some embodiments, R¹ is —(CH₂)₈—, and R² and R³ are selected from the group consisting of isooctyl and n-octyl.

Another aspect of the disclosure is directed to a polymer blend comprising a biopolymer (e.g., polylactic acid) and two or more impact modifiers, wherein at least one impact modifier is a polyester comprising a copolymer of an aliphatic diol, an aromatic diacid, and an aliphatic diacid; and at least one impact modifier is an ester of formula I as defined herein. In some embodiments, the two or more impact modifiers are present in a total amount of about 5 to about 30 parts by weight per hundred parts by weight of the biopolymer. In some embodiments, the polyester comprises a copolymer of 1,4-butanediol, terephthalate (or terephthalic acid), and adipate (or adipic acid).

Various biopolymers can be used in the disclosed compositions and methods, including, but not limited to polylactic acid, polyhydroxybutyrate, polyvinyl alcohol, polybutylene succinate, polyhydroxyalkanoates, polycaprolactones, aliphatic-aromatic copolyesters, starches, celluloses, and mixtures thereof.

### DETAILED DESCRIPTION

The claimed invention is susceptible of embodiments in many different forms. Preferred embodiments, as disclosed herein, are to be considered exemplary of the principles of the claimed invention and thus not intended to limit the broad aspects of the claimed invention to the embodiments illustrated.

Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

As used herein, the term “aliphatic” refers to non-aromatic compounds or functional groups. Aliphatic compounds or functional groups can be linear or branched, cyclic or acyclic, and saturated or unsaturated. Unsaturated aliphatic compounds or functional groups can have 1, 2, 3, or more double or triple bonds. Aliphatic compounds or functional groups optionally can be substituted, for example, with one or more hydroxy (—OH), amino (—NH₂), oxo (═O), halo (—F, —Cl, —Br, or —I), and thio (—SH) groups or a combination thereof. Aliphatic compounds or functional groups also can be interrupted by one or more heteroatoms such as O, S, or N.

As used herein, the term “aliphatic hydrocarbon group” refers to a non-aromatic hydrocarbon group, nonlimiting examples of which include alkyl groups, alkenyl groups, and alkynyl groups. Aliphatic hydrocarbon groups can be linear or branched, cyclic or acyclic, and saturated or unsaturated. Unsaturated aliphatic hydrocarbon groups can have 1, 2, 3, or more double or triple bonds. Aliphatic hydrocarbon groups optionally can be substituted, for example, with one or more hydroxy (—OH), amino (—NH₂), oxo (═O), halo (—F, —Cl, —Br, or —I), and thio (—SH) groups or a combination thereof. Aliphatic hydrocarbon groups also can be interrupted by one or more heteroatoms such as O, S, or N.

As used herein, the term “aromatic” refers to compounds or functional groups having a conjugated cyclic molecular structure, nonlimiting examples of which include benzene, naphthalene, phenyl, biphenyl, and phenoxybenzene. Aromatic compounds and functional groups include all carbon cyclic structures and cyclic structures including one or more heteratoms such as O, S, or N. Aromatic compounds or functional groups optionally can be substituted, for example, with one or more hydroxy (—OH), amino (—NH₂), oxo (═O), halo (—F, —Cl, —Br, or —I), and thio (—SH) groups or a combination thereof.

As used herein, the term “alkyl” refers to straight chained and branched saturated hydrocarbon groups, nonlimiting examples of which include methyl, ethyl, and straight chain and branched propyl and butyl groups. Alkyl groups optionally can be substituted, for example, with one or more hydroxy (—OH), amino (—NH₂), oxo (═O), halo (—F, —Cl, —Br, or —I), and thio (—SH) groups or a combination thereof. Alkyl groups also can be interrupted by one or more heteroatoms such as O, S, or N.

As used herein, the term “alkenyl” refers to straight chained and branched hydrocarbon groups containing at least one carbon-carbon double bond, nonlimiting examples of which include straight chain and branched ethenyl and propenyl groups. Alkenyl groups optionally can be substituted, for example, with one or more hydroxy (—OH), amino (—NH₂), oxo (═O), halo (—F, —Cl, —Br, or —I), and thio (—SH) groups or a combination thereof. Alkenyl groups also can be interrupted by one or more heteroatoms such as O, S, or N.

As used herein, the term “alkynyl” refers to straight chained and branched hydrocarbon groups containing at least one carbon-carbon triple bond, nonlimiting examples of which include straight chain and branched ethynyl and propynyl groups. Alkynyl groups optionally can be substituted, for example, with one or more hydroxy (—OH), amino (—NH₂), oxo (═O), halo (—F, —Cl, —Br, or —I), and thio (—SH) groups or a combination thereof. Alkynyl groups also can be interrupted by one or more heteroatoms such as O, S, or N.

As used herein, the term “biopolymer” refers to a polymer generated from renewable natural sources and/or a biodegradable polymer. Biopolymers generated from renewable natural sources can be made from at least 5% renewably-sourced materials, for example at least 10%, at least 20%, at least 30%, at least 40%, at least 50%, at least 60%, at least 70%, at least 80%, at least 90%, and/or 100% renewably-sourced materials. Biopolymers also include biodegradable polymers such as biodegradable petroleum-based polymers and biodegradable polymer blends (e.g., polymer blends of petroleum-based and plant-based polymers). Biopolymers can be produced by biological systems such as microorganisms, plants, or animals, or obtained by chemical synthesis.

As used herein, the term “impact modifier” refers to an additive having the ability to increase or decrease the impact resistance of material (e.g., a biopolymer), as determined by known methods for measuring impact resistance, such as a Gardner impact resistance (ASTM D5420) measurement.

The present disclosure is directed to a polymer blend comprising a biopolymer and one or more impact modifiers, wherein at least one impact modifier is an ester of formula I:

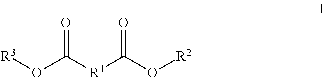

wherein R¹ is a substituted or unsubstituted aliphatic hydrocarbon group having 1 to 10 carbon atoms; and R² and R³ are each a substituted or unsubstituted aliphatic hydrocarbon group having 4 to 14 carbon atoms. In some embodiments, the one or more impact modifiers are present in a total amount of about 5 to about 30 parts by weight per hundred parts by weight of the biopolymer, for example, about 5 to about 15 parts by weight per hundred parts by weight of the biopolymer.

In some embodiments, R¹ is a substituted or unsubstituted aliphatic hydrocarbon group having 2 to 8 carbon atoms. In some embodiments, R² and R³ are each a substituted or unsubstituted aliphatic hydrocarbon group having 6 to 12 carbon atoms. In some embodiments, R² and R³ are each a substituted or unsubstituted aliphatic hydrocarbon group having 8 to 10 carbon atoms.

In some embodiments, R¹, R², and/or R³ are alkyl groups. R¹ alkyl groups can have, for example, from 1 to 10 carbon atoms, from 1 to 9 carbon atoms, from 2 to 8 carbon atoms, from 3 to 8 carbon atoms, from 4 to 8 carbon atoms, from 5 to 8 carbon atoms, from 6 to 8 carbon atoms, and/or from 7 to 8 carbon atoms. R¹, for example, can be selected from the group consisting of —(CH₂)₂—, —(CH₂)₃—, —(CH₂)₄—, —(CH₂)₅—, —(CH₂)₆—, —(CH₂)₇—, and —(CH₂)₈—. R¹ also can be selected from the group consisting of —(CH₂)₂— and —(CH₂)₈—. R² and R³ alkyl groups can have, for example, from 4 to 14 carbon atoms, from 8 to 10 carbon atoms, and/or from 8 to 9 carbon atoms. R² and R³, for example, can be selected from the group consisting of n-octyl, isooctyl (i.e., 6-methylheptyl), and 2-ethylhexyl.

In some embodiments, R¹ is an alkyl group having from 1 to 10 carbons, and R² and R³ are alkyl groups having from 4 to 14 carbons. In other embodiments, R¹ is an alkyl group having from 2 to 8 carbons, and R² and R³ are alkyl groups having from 6 to 12 carbons. In still other embodiments, R¹ is an alkyl group having from 2 to 8 carbons, and R² and R³ are alkyl groups having from 8 to 10 carbons. In yet other embodiments, R¹ is selected from the group consisting of —(CH₂)₂—, —(CH₂)₃—, —(CH₂)₄—, —(CH₂)₅—, —(CH₂)₆—, —(CH₂)₇—, and —(CH₂)₈—, and R² and R³ are selected from the group consisting of n-octyl, isooctyl, and 2-ethylhexyl. In other embodiments, R¹ is selected from the group consisting of —(CH₂)₂— and —(CH₂)₈—, and R² and R³ are selected from the group consisting of n-octyl, isooctyl, and 2-ethylhexyl. In other embodiments, R¹ is —(CH₂)₂—, and R² and R³ are selected from the group consisting of n-octyl, isooctyl, and 2-ethylhexyl. In other embodiments, R¹ is —(CH₂)₈—, and R² and R³ are selected from the group consisting of n-octyl, isooctyl, and 2-ethylhexyl.

The esters of formula I disclosed herein have at least two ester bonds, for example, three ester bonds, four ester bonds, or more. In some embodiments, the ester of formula I is selected from the group consisting of diisoctyl adipate, di-2-ethylhexyl adipate, diisooctyl sebacate, di-2-ethylhexyl sebacate, diisoctyl glutarate, di-2-ethylhexyl glutarate, diisooctyl succinate, di-2-ethylhexyl succinate, di-n-octyl sebacate, tributyl citrate, acetyl tributyl citrate, and tetraethylene glycol di-2-ethylhexoate. Advantageously, various esters of formula I can be partially or completely renewably sourced, in contrast to conventional petroleum-based polymeric ester additives, thereby providing reduced environmental impact. For example, diisooctyl sebacate, di-2-ethylhexyl sebacate, diisooctyl succinate, di-2-ethylhexyl succinate, di-n-octyl sebacate, tributyl citrate, and acetyl tributyl citrate are partially or completely renewably sourced.

In some embodiments, the esters of the polymer blends disclosed herein can be obtained by esterification of the corresponding aliphatic diacids with the corresponding aliphatic alcohols. Other known methods for preparing esters also can be used.

In some embodiments, the esters of the polymer blends disclosed herein are obtainable from substituted or unsubstituted aliphatic diacids (which also are known as dicarboxylic acids) including, but not limited to, saturated aliphatic diacids such as malonic acid (propanedioic acid), succinic acid (butanedioic acid), glutaric acid (pentanedioic acid), adipic acid (hexanedioic acid), pimelic acid (heptandioic acid), suberic acid (octanedioic acid), azelaic acid (nonanedioic acid), sebacic acid (decandioic acid), dodecandioic acid, cyclopentanedicarboxylic acid, cyclohexanedicarboxylic acid, cycloheptanedicarboxylic acid, and cyclooctanedicarboxylic acid; and unsaturated aliphatic diacids such as fumaric acid ((E)-butendioic acid), maleic acid ((Z)-butenedioic acid), cis-glutaconic acid ((Z)-2-pentenedioic acid), trans-glutaconic acid ((E)-2-pentenedioic acid), itaconic acid (2-methylidenebutanedioic acid), cis-γ-hydromuconic acid ((Z)-2-hexenedioic acid), and trans-γ-hydromuconic acid ((E)-2-hexenedioic acid). Other substituted or unsubstituted aliphatic diacids include, but are not limited to, aliphatic diacids having 3 to 12 carbon atoms, for example, 10 carbon atoms, 9 carbon atoms, 8 carbon atoms, 7 carbon atoms, 6 carbon atoms, 5 carbon atoms, and/or 4 carbon atoms.

In some embodiments, the esters of the polymer blends disclosed herein are obtainable from substituted or unsubstituted aliphatic alcohols including, but not limited to, saturated aliphatic alcohols such as saturated aliphatic alcohols such as butanol (e.g., 1-butanol, 2-butanol, iso-butanol, and tert-butanol), pentanol, hexanol, heptanol, octanol (e.g., 1-octanol, isooctanol, and 2-ethylhexanol), nonanol (e.g, pelargonic alcohol), decanol (e.g., 1-decanol, also known as capric alcohol), undecanol, dodecanol (lauryl alcohol), tridecanol, and tetradecanol (myristyl alcohol); and unsaturated aliphatic alcohols such as cis-9-dodecenol and cis-9-tetradecenol. Other substituted or unsubstituted aliphatic alcohols include, but are not limited to, alcohols having 1 to 14 carbon atoms, for example, 2 to 12 carbon atoms, 4 to 10 carbon atoms, 6 to 10 carbon atoms, 7 to 9 carbon atoms, and/or 8 carbon atoms. While not intending to be bound by theory, the aliphatic alcohols can improve the compatibility, increase the permanence, reduce exudation, and/or reduce extractability of the esters of the polymer blends disclosed herein.

In some embodiments, two or more impact modifiers are included, for example, three, four, five, or more impact modifiers. Various known impact modifiers can be included in addition to the ester of formula I. For example, when two or more impact modifiers are present, the impact modifiers can include two or more esters of formula I, for example three, four, five or more esters of formula I. The impact modifiers also can include at least one ester of formula I and at least one polyester. Additionally, the impact modifiers can include at least one ester of formula I and at least one acrylic polymer including, but not limited to, polyacrylic acid, polymethacrylic acid, poly(methyl acrylate), poly(methyl methacrylate), polyacrylamide, polymethacrylamide, poly(N-methyl acrylamide), and poly(N-methyl methacrylamide).

When two or more impact modifiers are used, the impact modifiers can be included in similar amounts. For example, a polymer blend can include the ester of formula I in an amount of about 5 to about 15 parts by weight per hundred parts by weight of the biopolymer and a second impact modifier in an amount of about 5 to about 15 parts by weight per hundred parts by weight of the biopolymer, such as the ester of formula I in an amount of about 5 to about 12 phr and the second impact modifier in an amount of about 5 to about 12 phr, and/or the ester of formula I in an amount of about 7 to about 10 phr and the second impact modifier in an amount of about 7 to about 10 phr. Specifically, a polymer blend can include the ester of formula I in an amount of about 5 to about 15 parts by weight per hundred parts by weight of the biopolymer and a polyester in an amount of about 5 to about 15 parts by weight per hundred parts by weight of the biopolymer, such as the ester of formula I in an amount of about 5 to about 12 phr and the polyester in an amount of about 5 to about 12 phr, and/or the ester of formula I in an amount of about 7 to about 10 phr and the polyester in an amount of about 7 to about 10 phr. Similarly, a polymer blend can include the ester of formula I in an amount of about 5 to about 15 parts by weight per hundred parts by weight of the biopolymer and an acrylic polymer in an amount of about 5 to about 15 parts by weight per hundred parts by weight of the biopolymer, such as the ester of formula I in an amount of about 5 to about 12 phr and the acrylic polymer in an amount of about 5 to about 12 phr and/or the ester of formula I in an amount of about 7 to about 10 phr and the acrylic polymer in an amount of about 7 to about 10 phr. Additionally, a polymer blend can include two or more esters of formula I, for example, a polymer blend can include a first ester of formula I in an amount of about 5 to about 15 parts by weight per hundred parts by weight of the biopolymer and a second ester of formula I in an amount of about 5 to about 15 parts by weight per hundred parts by weight of the biopolymer, such as the first ester of formula I in an amount of about 5 to about 12 phr and the second ester of formula I in an amount of about to about 12 phr and/or the first ester of formula I in an amount of about 7 to about 10 phr and the second ester of formula I in an amount of about 7 to about 10 phr.

When two or more impact modifiers are used, the impact modifiers also can be included in different amounts. For example, a polymer blend can include the ester of formula I in an amount greater than the amount of a second impact modifier, such as in a ratio of at least about 5 to 1, at least about 4 to 1, at least about 3 to 1, at least about 2 to 1, and/or at least about 1.5 to 1. A polymer blend also can include the ester of formula I in an amount less than the amount of a second impact modifier, such as in a ratio of at least about 1 to 1.5, at least about 1 to 2, at least about 1 to 3, at least about 1 to 4, and/or at least about 1 to 5. Specifically, a polymer blend can include the ester of formula I in an amount greater than the amount of a polyester, such as in a ratio of at least about 5 to 1, at least about 4 to 1, at least about 3 to 1, at least about 2 to 1, and/or at least about 1.5 to 1. A polymer blend also can include the ester of formula I in an amount less than the amount of a polyester, such as in a ratio of at least about 1 to 1.5, at least about 1 to 2, at least about 1 to 3, at least about 1 to 4, and/or at least about 1 to 5. Similarly, a polymer blend can include the ester of formula I in an amount greater than the amount of an acrylic polymer, such as in a ratio of at least about 5 to 1, at least about 4 to 1, at least about 3 to 1, at least about 2 to 1, and/or at least about 1.5 to 1. A polymer blend also can include the ester of formula I in an amount less than the amount of a polyester, such as in a ratio of at least about 1 to 1.5, at least about 1 to 2, at least about 1 to 3, at least about 1 to 4, and/or at least about 1 to 5. Additionally, a polymer blend can include two esters of formula I in different amounts, such as in a ratio of at least about 5 to 1, at least about 4 to 1, at least about 3 to 1, at least about 2 to 1, and/or at least about 1.5 to 1.

Polyesters suitable for combining with esters of formula I include copolymers of aliphatic diols and aliphatic diacids. Aliphatic diols include, but are not limited to, substituted or unsubstituted C₂ to C₂₀ aliphatic diols, substituted or unsubstituted C₂ to C₁₀ aliphatic diols, substituted or unsubstituted C₂ to C₆ aliphatic diols, and/or substituted or unsubstituted C₂ to C₄ aliphatic diols. Aliphatic diacids include, but are not limited to, substituted or unsubstituted C₂ to C₂₀ aliphatic diacids, substituted or unsubstituted C₂ to C₁₀ aliphatic diacids, substituted or unsubstituted C₄ to C₈ aliphatic diacids, and/or substituted or unsubstituted C₄ to C₆ aliphatic diacids. Optionally, the polyesters can be terminated with alcohols including, but not limited to, substituted or unsubstituted C₁ to C₂₀ aliphatic alcohols, substituted or unsubstituted C₂ to C₁₈ aliphatic alcohols, substituted or unsubstituted C₄ to C₁₄ aliphatic alcohols, and/or substituted or unsubstituted C₆ to C₁₂ aliphatic alcohols. Exemplary polyesters include a copolymer of 1,2-propanediol and succinic acid, and a copolymer of 1,2-propanediol and succinic acid terminated with decanol.

Polyesters suitable for combining with esters of formula I also include copolymers of aliphatic diols and aromatic diacids, for example, copolymers of aliphatic diols, aromatic diacids, and aliphatic diacids. Suitable aliphatic diacids and diols are discussed above. Aromatic diacids include, but are not limited to, substituted or unsubstituted C₄ to C₁₀ aromatic diacids, and/or substituted or unsubstituted C₆ to C₁₀ aromatic diacids. Aromatic diacids having fewer than six carbon atoms typically include one or more heteroatoms as part of the aromatic ring. Exemplary aromatic diacids include, but are not limited to, terephthalic acid, isophthalic acid, 5-sulfoisophthalic acid, and 2,6-naphthalenedicarboxylic acid. Exemplary polyesters include a copolymer of 1,4-butanediol, terephthalate (or terephthalic acid), and adipate (or adipic acid).

The biopolymers according to the disclosure include polymers generated from renewable natural sources and/or biodegradable polymers. Exemplary biopolymers include, but are not limited to, polylactic acid (e.g., BIO-FLEX, available from FKuR Kunststoff GmbH, Germany; ECOLOJU, available from Mitsubishi Plastics, Inc., Japan; HYCAIL, available from Hycail, the Netherlands; INGEO 2002D, available from NatureWorks LLC, Minnetonka, Minn.), polyhydroxybutyrate (e.g., BIOMER L, available from Biomer, Germany), polyvinyl alcohol (e.g., BIOSOL, available from Panteco, Italy; GOHSENOL, available from Nippon Gohsei, Japan; MAVINSOL, available from Panteco, Italy; MOWIOL, available from Kuraray America, Inc., Houston, Tex.; KURARAY POVAL, available from Kuraray America, Inc., Houston, Tex.), polybutylene succinate (e.g., GREEN PLASTICS, available from Mitsubishi, Japan), polyhydroxyalkanoates (e.g., MIREL, available from Telles (Metabolix and Archer Daniels Midland Company), Lowell, Mass.), polycaprolactones (e.g., CAPA, available from Solvay, United Kingdom), copolyesters (e.g, CADENCE, available from Eastman, Kingsport, Tenn.), aliphatic-aromatic copolyesters (e.g., EASTAR, available from Eastman, Kingsport, Tenn.; ECOFLEX, available from BASF, Germany), starches (e.g., BIOPLAST, available from Biotec, Germany; BIOPAR, available from BIOP Biopolymer Technologies AG, Dresden, Germany; CEREPLAST COMPOSTABLES and CEREPLAST HYBRID RESINS, available from Cereplast, Hawthorne, Calif.; COHPOL, available from VTT Chemical Technology, Finland; ECOPLAST, available from Groen Granulaat, the Netherlands; EVERCORN, available from Japan Corn Starch Co., Japan; MATER-BI, available from Novamont, Italy; PLANTIC, available from Plantic Technologies Limited, Victoria, Australia; SOLANYL, available from Rodenburg Polymers, the Netherlands; SORONA, available from DuPont, Wilmington, Del.; RE-NEW 400, available from StarchTech, Golden Valley, Minn.; TERRATEK, available from MGP Ingredients, Atchison, Kans.; VEGEMAT, available from Vegeplast, France), celluloses (e.g., BIOGRADE, available from FKuR Kunststoff GmbH, Germany), other biopolymers (e.g., LUNARE SE, available from Nippon Shokubai, Japan), and mixtures thereof. A preferred biopolymer is polylactic acid.

The impact modifiers disclosed herein are combined with one or more biopolymers to form a polymer blend having increased impact resistance compared to the impact resistance of the biopolymer in the absence of added impact modifier(s). The polymer blends disclosed herein demonstrate, for example, increased Garner impact resistance as determined, for example, by ASTM D5420, reduced glass transition temperatures, increased elongation at break, reduced tensile strength, and/or reduced tensile at break compared to the corresponding properties of the biopolymer. The total amount of impact modifiers in the polymer blend can be from about 5 to about 30 parts by weight per hundred parts by weight of the biopolymer (phr), for example, from about 5 to about 15 phr, from about 8 to about 25 phr, from about 10 to about 20 phr, and/or from about 12 to about 18 phr. The total amount of the impact modifiers in the polymer blend also can be less than about 5 phr or greater than 30 phr.

The polymer blends disclosed herein can have at least a 1.5-fold increase in impact resistance compared to the impact resistance of the unmodified biopolymer. For example, the polymer blends disclosed herein can have at least a 2-fold, at least a 3-fold, at least a 4-fold, at least a 5-fold, at least a 10-fold, at least a 15-fold, and/or at least a 20-fold increase in impact resistance compared to the impact resistance of the unmodified biopolymer. The polymer blends also can have less than a 1.5-fold increase in impact resistance, or greater than a 20-fold increase in impact resistance compared to the impact resistance of the unmodified biopolymer. Impact resistance can be measured, for example, by Gardner impact resistance (ASTM D5420). The polymer blends can have various impact resistance values, for example, greater than about 2 in lbf, greater than about 4 in lbf, greater than about 6 in lbf, greater than about 8 in lbf, greater than about 10 in lbf, greater than about 12 in lbf, greater than about 14 in lbf, greater than about 16 in lbf, greater than about 18 in lbf, and/or greater than about 20 in lbf. The polymer blends also can have impact resistance values less than 2 in lbf and greater than 20 in lbf.

The polymer blends disclosed herein can have at least a 5% reduction in glass transition temperature compared to the glass transition temperature of the unmodified biopolymer. For example, the polymer blends disclosed herein can have at least a 10%, at least a 15%, at least a 20%, at least a 25%, at least a 30%, at least a 40%, and/or at least a 50% reduction in glass transition temperature compared to the glass transition temperature of the unmodified biopolymer. The polymer blends also can have less than a 5% reduction in glass transition temperature, or greater than a 50% reduction in glass transition temperature compared to the glass transition temperature of the unmodified biopolymer. The polymer blends can have various glass transition temperatures, for example, about 20° C. to about 60° C., about 25° C. to about 55° C., about 30° C. to about 50° C., and/or about 35° C. to about 45° C. The polymer blends also can have glass transition temperatures less than 20° C. and greater than 60° C.

The polymer blends disclosed herein can have at least a 2-fold increase in elongation percentage at break compared to the elongation percentage at break of the unmodified biopolymer. For example, the polymer blends disclosed herein can have at least a 3-fold, at least a 4-fold, at least a 5-fold, at least a 10-fold, at least a 20-fold, at least a 30-fold, at least a 40-fold, at least a 50-fold, at least a 60-fold, at least a 70-fold, at least a 80-fold, at least a 90-fold, and/or at least a 100-fold, at least a 150-fold, at least a 200-fold increase in elongation percentage at break compared to the elongation percentage at break of the unmodified biopolymer. The polymer blends also can have less than a 2-fold increase in elongation percentage at break, or greater than a 200-fold increase in elongation percentage at break compared to the elongation percentage at break of the unmodified biopolymer. The polymer blends can have various elongation percentages at break, for example, at least 10%, at least 15%, at least 20%, at least 25%, at least 30%, at least 40%, at least 50%, at least 60%, at least 70%, at least 80%, at least 90%, at least 100%, at least 120%, at least 140%, at least 160%, at least 180%, and/or at least 200%. The polymer blends also can have elongation percentages at break less than 10% or greater than 200%.

The polymer blends disclosed herein can have at least a 5% reduction in tensile strength (modulus) compared to the tensile strength of the unmodified biopolymer. For example, the polymer blends disclosed herein can have at least a 10%, at least a 15%, at least a 20%, at least a 25%, at least a 30%, at least a 40%, and/or at least a 50% reduction in tensile strength compared to the tensile strength of the unmodified biopolymer. The polymer blends also can have less than a 5% reduction in tensile strength or greater than a 50% reduction in tensile strength compared to the tensile strength of the unmodified biopolymer. The polymer blends can have various tensile strengths, for example, about 10 MPa to about 60 MPa, about 15 MPa to about 50 MPa, about 20 MPa to about 45 MPa, about 25 MPa to about 40 MPa, and/or about 30 MPa to about 35 MPa. The polymer blends also can have tensile strengths less than 10 MPa and greater than 60 MPa.

The polymer blends disclosed herein can have at least a 5% reduction in tensile at break compared to the tensile at break of the unmodified biopolymer. For example, the polymer blends disclosed herein can have at least a 10%, at least a 15%, at least a 20%, at least a 25%, at least a 30%, at least a 40%, and/or at least a 50% reduction in tensile at break compared to the tensile at break of the unmodified biopolymer. The polymer blends also can have less than a 5% reduction in tensile at break or greater than a 50% reduction in tensile at break compared to the tensile at break of the unmodified biopolymer. The polymer blends can have various tensile values at break, for example, about 10 MPa to about 60 MPa, about 15 MPa to about 50 MPa, about 20 MPa to about 45 MPa, about 25 MPa to about 40 MPa, and/or about 30 MPa to about 35 MPa. The polymer blends also can have tensile values at break less than 10 MPa and greater than 60 MPa.

The polymer blends disclosed herein are expected to demonstrate stability upon storage. In particular, the impact modifiers of the polymer blends disclosed herein are expected to demonstrate resistance to exudation (bleeding) for at least about 10 days of storage, for example, for at least about 20 days, at least about 30 days, at least about 50 days, at least about 70 days, at least about 90 days, at least about 120 days, at least about 150 days, at least about 180 days, at least about 210 days, at least about 250 days, and/or at least about 270 days or longer.

Another aspect of the present invention provides methods for increasing the impact resistance of a biopolymer (e.g., polylactic acid) comprising mixing the biopolymer and one or more impact modifiers, wherein at least one impact modifier is an ester of formula I as defined herein. In some embodiments, the impact modifier is an ester of formula I:

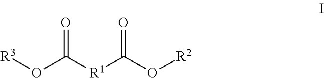

wherein R¹ is a substituted or unsubstituted aliphatic hydrocarbon group having 1 to 10 carbon atoms; and R² and R³ are each a substituted or unsubstituted aliphatic hydrocarbon group having 4 to 14 carbon atoms. In some embodiments R¹ is selected from the group consisting of —(CH₂)₂— and —(CH₂)₈—, and R² and R³ are selected from the group consisting of n-octyl, isooctyl, and 2-ethylhexyl. In some embodiments R¹ is —(CH₂)₂—, and R² and R³ are selected from the group consisting of n-octyl, isooctyl, and 2-ethylhexyl. In some embodiments R¹ is —(CH₂)₈—, and R² and R³ are selected from the group consisting of n-octyl, isooctyl, and 2-ethylhexyl. In some embodiments the one or more impact modifiers are present in a total amount of about 5 to about 30 parts by weight per hundred parts by weight of the biopolymer, for example, about 5 to about 15 parts by weight per hundred parts by weight of the biopolymer. In some embodiments, two or more impact modifiers are present, such as two or more esters of formula I, one or more esters of formula I and one or more polyesters, and/or one or more esters of formula I and one or more acrylic polymers. In some embodiments, an ester of formula I is present in an amount of about 5 to about 15 parts by weight per hundred parts by weight of the biopolymer and a polyester or acrylic polymer is present in an amount of about 5 to about 15 parts by weight per hundred parts by weight of the biopolymer. In some embodiments, the polyester comprises a copolymer of an aliphatic diol and an aliphatic diacid, such as a copolymer of 1,2-propanediol and succinic acid, and a copolymer of 1,2-propanediol and succinic acid terminated with decanol. In some embodiments, the polyester comprises a copolymer of an aliphatic diol, an aromatic diacid, and an aliphatic diacid, such as a copolymer of 1,4-butanediol, terephthalate, and adipate.

Another aspect of the present invention provides methods for reducing the glass transition temperature of a biopolymer (e.g., polylactic acid) comprising mixing the biopolymer and one or more impact modifiers, wherein at least one impact modifier is an ester of formula I as defined herein.

Another aspect of the present invention provides methods for increasing the elongation at break of a biopolymer (e.g., polylactic acid) comprising mixing the biopolymer and one or more impact modifiers, wherein at least one impact modifier is an ester of formula I as defined herein.

Another aspect of the present invention provides methods for reducing the tensile strength of a biopolymer (e.g., polylactic acid) comprising mixing the biopolymer and one or more impact modifiers, wherein at least one impact modifier is an ester of formula I as defined herein.

Another aspect of the present invention provides methods for reducing tensile at break of a biopolymer (e.g., polylactic acid) comprising mixing the biopolymer and one or more impact modifiers, wherein at least one impact modifier is an ester of formula I as defined herein.

The disclosure may be better understood by reference to the following examples which are not intended to be limiting, but rather only set forth exemplary embodiments in accordance with the disclosure.

### EXAMPLES

Abbreviations used in the Examples are defined in the following table.

| Abbreviation | Material |
|---|---|
| DIOA | diisoctyl adipate |
| DOA | di-2-ethylhexyl adipate |
| DIOS | diisooctyl sebacate |
| DOS | di-2-ethylhexyl sebacate |
| DIOG | diisoctyl glutarate |
| DOG | di-2-ethylhexyl glutarate |
| DIOSu | diisooctyl succinate |
| DOSu | di-2-ethylhexyl succinate |
| R-4010 | HALLGREEN R-4010 renewable ester |
| | (HallStar) |
| R-4028 | HALLGREEN R-4028 renewable ester |
| | (HallStar) |
| DNOS | di-n-octyl sebacate |
| TBC | tributyl citrate |
| TBC-A | acetyl tributyl citrate |
| T804 | TEGMER 804 tetraethylene glycol di-2- |
| | ethylhexoate (HallStar) |
| ECOFLEX | ECOFLEX F BX 7011 biodegradable plastic |
| | (1,4-butandiol, terephthalate, adipic acid |
| | copolymer) (BASF) |
| PolySu | 1,2-propanediol, succinic acid copolymer |
| | terminated with decanol |
| BIOSTRENGTH | BIOSTRENGTH 200 acrylic polymer |
| | (Arkema) |

### Example 1

### Preparation of PLA-Ester Blends Including One Impact Modifier

Polymer blends of polylactic acid (PLA) with various ester additives were prepared by combining INGEO 2002D polylactide resin (NatureWorks LLC) with 10 parts by weight per hundred parts by weight resin (phr) of ester additive as shown in Table 1. Properties of the blends are provided in Table 1.

TABLE 1

| | PLA Blend | | | | | | | |
|---|---|---|---|---|---|---|---|---|
| | A1 | A2 | A3 | A4 | A5 | A6 | A7 | A8 |
| Ester Additive (10 phr) | DIOA | DOA | DIOS | DOS | DIOG | DOG | DIOSu | DOSu |

Melt Viscosity 31.5 RPM, 210° C.

| | | | | | | | | |
|---|---|---|---|---|---|---|---|---|
| Maximum Torque, mg | 2400 | 2400 | 2400 | 2200 | 2500 | 2500 | 2400 | 2400 |
| Melt Time, min. | 3.0 | 3.0 | 3.0 | 3.0 | 3.0 | 3.0 | 3.0 | 4.0 |
| Melt Temperature, ° C. | 196 | 196 | 197 | 198 | 196 | 196 | 197 | 206 |
| Melt Torque, mg | 91 | 71 | 82 | 71 | 61 | 61 | 61 | 51 |
| Totalized Energy, kJ | 2.8 | 2.9 | 2.7 | 2.3 | 2.8 | 2.8 | 2.3 | 1.0 |

DSC ASTM D3418-03 10° C./minute

| | | | | | | | | |
|---|---|---|---|---|---|---|---|---|
| Tm, ° C. first heat data | 86.67 | 95.85 | 108.6 | 97.42 | 90.56 | 90.91 | 101.7 | 95.8 |
| Tc, ° C. second heat data | 135.2, 147.1 | 147.4 | 142.1, 149.2 | 142.7 | 144.17 | 136.4 | 145.8 | 144.4 |
| | | | | 149.5 | | 147.3 | | |
| Tg, ° C. second heat data | 37 | 40 | 48 | 49 | 38 | 38 | 38 | 37 |

Original Physical Properties

| | | | | | | | | |
|---|---|---|---|---|---|---|---|---|
| Tensile Strength, MPa | 34.6 | 32.8 | 28.4 | 28.2 | 46 | 35.2 | 39.3 | 41.2 |
| psi | 5025 | 4760 | 4120 | 4090 | 6670 | 5105 | 5695 | 5975 |
| Tensile at Break, MPa | 19.3 | 21.6 | 24.8 | 18 | 46 | 24.1 | 39.3 | 41.2 |
| psi | 2805 | 3140 | 3590 | 2610 | 6670 | 3495 | 5695 | 5975 |
| Elongation @ Break, % | 57 | 50 | 25 | 100 | 0 | 35 | 0 | 0 |
| Hardness Duro D, pts. | 80 | 80 | 79 | 80 | 80 | 79 | 80 | 77 |
| Specific Gravity | 1.222 | 1.222 | 1.213 | 1.212 | 1.225 | 1.221 | 1.232 | 1.225 |

Gardner Impact Resistance, ASTM D5420

| | | | | | | | | |
|---|---|---|---|---|---|---|---|---|
| in lbf | 2.1 | 3.9 | 12.8 | 7.2 | 3.4 | 2.1 | 8.3 | 2.9 |
| Joules | 0.2 | 0.4 | 1.4 | 0.8 | 0.4 | 0.2 | 0.9 | 0.3 |

| | PLA Blend | | | | | | | |
|---|---|---|---|---|---|---|---|---|
| | A9 | A10 | A11 | A12 | A13 | A14 | A15 | PLA |
| Ester Additive (10 phr) | R4010 | R4028 | DNOS | TBC | TBC-A | T804 | ECO- | None |
| | | | | | | | FLEX | |
| Melt Viscosity 31.5 RPM, 210° C. | | | | | | | | |
| Maximum Torque, mg | 2090 | 2315 | 2250 | 2138 | 2250 | 2000 | 2000 | 2330 |
| Melt Time, min. | 5.3 | 5.2 | 3.3 | 6 | 6 | 4.1 | 7.65 | 6.7 |
| Melt Temperature, ° C. | 207 | 207 | 199 | 206 | 206 | 206 | 210 | 211 |
| Melt Torque, mg | 51.5 | 43.8 | 67 | 123.5 | 110.5 | 175 | 152.5 | 253.2 |
| Totalized Energy, kJ | 2.7 | 2.8 | 3.0 | 3.8 | 3.2 | 2.9 | 5.5 | 4.78 |
| DSC ASTM D3418-03 10° C./minute | | | | | | | | |
| Tm, ° C. first heat data | 118 | 106 | 118 | 111 | 117 | — | 151 | 151 |
| Tc, ° C. second heat data | 149 | 140, 151 | 145 | 142, 149 | 145 | — | 128 | UD |
| Tg, ° C. second heat data | 40 | 45 | 50 | 41 | 44 | — | 60 | 60 |
| Original Physical Properties | | | | | | | | |
| Tensile Strength, MPa | 39.8 | 33.7 | 26.6 | 46.5 | 45.7 | 46.4 | 41.6 | 45.8 |
| psi | 5780 | 4895 | 3855 | 6745 | 6630 | 6730 | 6030 | 6645 |
| Tensile at Break, MPa | 40.5 | 28.2 | 25.8 | 46.5 | 45.7 | 46.4 | 43.3 | 45.8 |
| psi | 5875 | 4090 | 3670 | 6745 | 6630 | 6730 | 6280 | 6645 |
| Elongation @ Break, % | 3 | 27 | 47 | 0 | 0 | 0 | 0 | 2 |
| Hardness Duro D, pts. | 71 | 75 | 77 | 76 | 73 | 74 | 79 | 77 |
| Specific Gravity | 1.238 | 1.23 | 1.21 | 1.24 | 1.24 | 1.236 | 1.250 | 1.253 |
| Gardner Impact Resistance, ASTM D5420 | | | | | | | | |
| in lbf | 1.8 | 4 | 10.8 | 1.9 | 2.4 | 1.79 | 8.5 | 1.6 |
| Joules | 0.2 | 0.46 | 1.24 | 0.21 | 0.27 | 0.2 | 0.96 | 0.19 |

The polymer blends demonstrated improved Gardner impact resistance compared to unmodified PLA. In particular, blends of PLA with diisooctyl sebacate (blend A3) and di-n-octyl sebacate (blend A11) demonstrated significant improvements in impact resistance compared to both unmodified PLA and PLA blended with a commercially available petroleum-based polymeric ester additive (blend A15). Additionally, blends of PLA with diisooctyl succinate (blend A7) and di-2-ethylhexyl sebacate (blend A4) demonstrated large improvements in impact resistance compared to unmodified PLA.

Polymer blends prepared using the esters listed in Table 1 demonstrated several additional benefits. In particular, when the ester blends were formed into films, all ester blends A1 to A14 were transparent, which is frequently a desired property for packaging and other materials. In contrast, films formed from a blend having a petroleum based ester additive (blend A15) lacked the transparency demonstrated by blends A1 to A14. In addition, all ester blends A1 to A14 demonstrated reduced brittleness compared to both unmodified PLA and PLA blended with ECOFLEX (blend A15), as evidenced by a reduction in Tg for blends A1 to A14. Furthermore, processing improvements were demonstrated for the blends, including a reduction in the energy required to masticate the PLA formulations and a reduction in processing temperature.

### Example 2

### Preparation of PLA-Ester Blends Including Two Impact Modifiers at 5 phr Each

Polymer blends of polylactic acid (PLA) with two ester additives were prepared by combining INGEO 2002D polylactide resin (NatureWorks LLC) with 5 parts by weight per hundred parts by weight resin (phr) of each ester additive as shown in Table 2. Blend B2 included R-4010 renewable ester (Hallstar) and di-n-octyl sebacate, and blend B3 included diisooctyl succinate and di-n-octyl sebacate. Blends B4 to B7 included a polyester (PolySu) prepared from succinic acid, 1,2-propanediol, and decanol (approximate molecular weight 2200 g/mol), and a second ester selected from di-n-octyl sebacate, di-2-ethylhexyl sebacate, diisooctyl sebacate, and diisooctyl succinate. Polymer blends also were prepared that included only one ester additive. Specifically, blend B1 included 10 phr PolySu, and blend B8 included 10 phr ECOFLEX. Properties of the blends are provided in Table 2.

TABLE 2

| | PLA Blend | | | | | | | | |
|---|---|---|---|---|---|---|---|---|---|
| | B1 | B2 | B3 | B4 | B5 | B6 | B7 | B8 | PLA |
| First Ester Additive | PolySu | R-4010 | DIOSu | PolySu | PolySu | PolySu | PolySu | ECO- | None |
| (5 Phr) | | | | | | | | FLEX | |
| Second Ester Additive | PolySu | DNOS | DNOS | DNOS | DOS | DIOS | DIOSu | ECO- | None |
| (5 Phr) | | | | | | | | FLEX | |

Melt Viscosity 31.5 RPM, 210° C.

| | | | | | | | | | |
|---|---|---|---|---|---|---|---|---|---|
| Maximum Torque, mg | 2500 | 2400 | 2200 | 2200 | 2250 | 2000 | 2000 | 2000 | 2330 |
| Melt Time, min. | 4.8 | 5 | 5 | 3.8 | 3.5 | 5.1 | 5.0 | 7.65 | 6.7 |
| Melt Temperature, ° C. | 205 | 205 | 205 | 203 | 199 | 208 | 207 | 210 | 211 |
| Melt Torque, mg | 81 | 81.6 | 50.97 | 61 | 81 | 55 | 61 | 152.5 | 253.2 |
| Totalized Energy, kJ | 2.6 | 3.45 | 3 | 2.2 | 2.7 | 1.4 | 1.3 | 5.5 | 4.78 |

DSC ASTM D3418-03 10° C./minute

| | | | | | | | | | |
|---|---|---|---|---|---|---|---|---|---|
| Tm, ° C. first heat data | 109.9 | — | — | 103.3 | 96.6 | 93.6 | 104 | 151 | 151 |
| Tc, ° C. second heat | 141.8, | — | — | 141.0, | 140.6, | 137.9, | 144.5 | 128 | — |
| data | 151 | | | 149.6 | 150.6 | 148.7 | | | |
| Tg, ° C. second heat | 45.4 | — | — | 44.8 | 43.9 | 41.3 | 40.6 | 60 | 60 |
| data | | | | | | | | | |

Original Physical Properties

| | | | | | | | | | |
|---|---|---|---|---|---|---|---|---|---|
| Tensile Strength, MPa | 32.2 | 35.6 | 32.2 | 35.4 | 37.6 | 38 | 45.1 | 41.6 | 45.8 |
| psi | 4670 | 5160 | 4675 | 5130 | 5455 | 5515 | 6535 | 6030 | 6645 |
| Tensile at Break, MPa | 32.2 | — | — | 29.7 | 32.4 | 35.7 | 45.1 | 43.3 | 45.8 |
| psi | 4670 | — | — | 4310 | 4695 | 5175 | 6535 | 6280 | 6645 |
| Elongation @ Break, % | 0 | 58 | 69 | 15 | 24 | 1 | 0 | 0 | 2 |
| Hardness Duro D, pts. | 76 | 77 | 75 | 79 | 77 | 79 | 80 | 79 | 77 |
| Specific Gravity | 1.236 | 1.215 | 1.222 | 1.231 | 1.22 | 1.233 | 1.234 | 1.250 | 1.253 |

Gardner Impact Resistance, ASTM D5420

| | | | | | | | | | |
|---|---|---|---|---|---|---|---|---|---|
| in lbf | 3.2 | 5.5 | 6.75 | 3.6 | 4 | 3.1 | 4.5 | 8.5 | 1.6 |
| Joules | 0.4 | 0.62 | 0.76 | 0.4 | 0.5 | 0.4 | 0.5 | 0.96 | 0.19 |

The polymer blends having two ester additives demonstrated improved Gardner impact resistance compared to unmodified PLA. In particular, blends of PLA with the combination of R-4010 and di-n-octyl sebacate (blend B2), and the combination of diisooctyl succinate and di-n-octyl sebacate (blend B3) demonstrated large improvements in impact resistance compared to unmodified PLA. Blends of PLA with the combination of PolySu and a second ester additive (blends B4 to B7) also demonstrated large improvements in impact resistance compared to unmodified PLA. Formulations having the combination of 5 phr ester additive and 5 phr PolySu demonstrated smaller improvements in impact resistance as compared to the formulations of Example 1 having 10 phr of the same ester additive (compare blends B4 and All, blends B5 and A4, blends B6 and A3, and blends B7 and A7). However, inclusion of PolySu in polymer blends can be desirable because PolySu is completely renewably sourced.

Advantageously, when the ester blends are formed into films, all ester blends B1 to B7 are transparent, which is frequently a desired property for packaging and other materials. In contrast, films formed from a blend having a petroleum based ester additive (blend B8) lacked the transparency demonstrated by blends B1 to B7. In addition, all ester blends B1 to B7 demonstrated reduced brittleness compared to both unmodified PLA and PLA blended with ECOFLEX (blend B8), as evidenced by a reduction in Tg for blends B1 to B7. Furthermore, processing improvements were demonstrated for the blends, including a reduction in the energy required to masticate the PLA formulations and a reduction in processing temperature.

### Example 3

### Preparation of PLA-Ester Blends Including Two Impact Modifiers at 10 phr Each

Polymer blends of polylactic acid (PLA) with ECOFLEX F BX 7011 biodegradable plastic (1,4-butandiol, terephthalate, adipic acid copolymer) (BASF) and a second ester additive were prepared by combining INGEO 2002D polylactide resin (NatureWorks LLC) with 10 parts by weight per hundred parts by weight resin (phr) of ECOFLEX and 10 phr of a second ester additive as shown in Table 3. Blend C19 included ECOFLEX and a polyester (PolySu) prepared from succinic acid, 1,2-propanediol, and decanol. A polymer blend also was prepared by combining INGEO 2002D polylactide resin with 10 phr ECOFLEX. Properties of the blends are provided in Table 3.

TABLE 3

| | PLA Blend | | | | | | | | | |
|---|---|---|---|---|---|---|---|---|---|---|
| | C1 | C2 | C3 | C4 | C5 | C6 | C7 | C8 | C9 | C10 |
| First Ester Additive | ECO- | ECO- | ECO- | ECO- | ECO- | ECO- | ECO- | ECO- | ECO- | ECO- |
| (10 phr) | FLEX | FLEX | FLEX | FLEX | FLEX | FLEX | FLEX | FLEX | FLEX | FLEX |
| Second Ester Additive | None | DOA | DIOA | DOS | DIOS | DOG | DIOG | DOSu | DIOSu | PolySu |
| (10 phr) | | | | | | | | | | |

Melt Viscosity 31.5 RPM, 210° C.

| | | | | | | | | | | |
|---|---|---|---|---|---|---|---|---|---|---|
| Maximum Torque, mg | 2000 | 2500 | 2200 | 2000 | 2200 | 2000 | 2000 | 2000 | 2000 | 2000 |
| Melt Time, min. | 7.65 | 5 | 5.5 | 5 | 5 | 5 | 5 | 5 | 4.5 | 4.6 |
| Melt Temperature, ° C. | 210 | 206 | 206 | 206 | 206 | 205 | 205 | 206 | 204 | 203 |
| Melt Torque, mg | 152.5 | 40.8 | 31.4 | 0 | 0 | 30 | 61 | 41 | 41 | 81 |
| Totalized Energy, kJ | 5.5 | 3.02 | 2.5 | 2.4 | 2.49 | 2.7 | 2.7 | 2.6 | 2.5 | 1.9 |

DSC ASTM D3418-03 10° C./minute

| | | | | | | | | | | |
|---|---|---|---|---|---|---|---|---|---|---|
| Tm, ° C. first heat data | 151 | 91.36 | 91.7 | 102.73 | 101.2 | 84.38 | 80.1 | 90.7 | 88.72 | 96.8 |
| Tc, ° C. second heat data | 128 | 138.0, | 139.8, | 142.5, | 142.9, | 136.7, | 134.3, | 139.7, | 137.5, | 142.5, |
| | | 147.7 | 148.1 | 149.0 | 149.5 | 145.7 | 144.4 | 149.0 | 149.2 | 151.0 |
| Tg, ° C. second heat data | 60 | 39.91 | 42.75 | 48.72 | 48.57 | 38.69 | 37.3 | 41.6 | 40.35 | 45.9 |

Original Physical Properties

| | | | | | | | | | | |
|---|---|---|---|---|---|---|---|---|---|---|
| Tensile Strength, MPa | 41.6 | 28.5 | 30.7 | 27.7 | 29.0 | 31.9 | 31.3 | 32.0 | 30.5 | 48.1 |
| psi | 6030 | 4135 | 4455 | 4015 | 4205 | 4625 | 4535 | 4635 | 4425 | 6970 |
| Tensile at Break, MPa | 43.3 | 21.4 | 17.9 | 20.4 | 20.6 | 22.4 | 20.2 | 22.9 | 21.8 | 46.3 |
| psi | 6280 | 3105 | 2595 | 2955 | 2985 | 3245 | 2930 | 3320 | 3160 | 6720 |
| Elongation @ Break, % | 0 | 180 | 108 | 320 | 145 | 160 | 195 | 245 | 145 | 1 |
| Hardness Duro D, pts. | 79 | 75 | 77 | 75 | 79 | 75 | 76 | 72 | 73 | 75 |
| Specific Gravity | 1.250 | 1.216 | 1.199 | 1.218 | 1.220 | 1.224 | 1.226 | 1.229 | 1.228 | 1.243 |

Gardner Impact Resistance, ASTM D5420

| | | | | | | | | | | |
|---|---|---|---|---|---|---|---|---|---|---|
| in lbf | 8.51 | 16.3 | 20.1 | 14.50 | 12.50 | 12.20 | 4.75 | 12.90 | 18.2 | 8.1 |
| Joules | 0.96 | 1.8 | 2.3 | 1.64 | 1.41 | 1.38 | 0.54 | 1.46 | 2.1 | 0.9 |

The polymer blends demonstrated improved Gardner impact resistance compared to unmodified PLA, for which Gardner impact resistance of 1.6 in lbf (0.19 Joules) has been demonstrated (see, Tables 1 and 2). In particular, blends of PLA with a combination of 10 phr ECOFLEX and 10 phr of a second ester selected from di-2-ethylhexyl adipate, diisoctyl adipate, di-2-ethylhexyl sebacate, diisooctyl sebacate, di-2-ethylhexyl glutarate, di-2-ethylhexyl succinate, and diisooctyl succinate (blends C2 to C6 and C8 to C9) demonstrated significant improvements in impact resistance compared to both unmodified PLA and PLA blended with ECOFLEX (blend C1). Additionally, blends of PLA with diisoctyl glutarate (blend C7) and PolySu (blend C10) demonstrated large improvements in impact resistance compared to unmodified PLA. Moreover, several formulations having the combination of 10 phr ECOFLEX and 10 phr of a second ester additive demonstrated larger improvements in impact resistance as compared to the formulations of Example 1 having 10 phr of the same ester additive without ECOFLEX (compare blends C2 and A2, blends C3 and A1, blends C4 and A4, blends C6 and A6, blends C8 and A8, and blends C9 and A7).

In addition, all ester blends C2 to C10 demonstrated reduced brittleness compared to both unmodified PLA and PLA blended with ECOFLEX (blend C1), as evidenced by both a reduction in Tg and a substantial increase in elongation at break for blends C2 to C10. Blends C2 to C10 also demonstrated reduced tensile strength and reduced tensile at break as compared to both unmodified PLA and PLA blended with ECOFLEX (blend C1). Furthermore, processing improvements were demonstrated for the blends, including a reduction in the energy required to masticate the PLA formulations and a reduction in processing temperature.

### Example 4

### Preparation of PLA-Ester Blends Including Two Impact Modifiers at 5 phr Each

Polymer blends of polylactic acid (PLA) with ECOFLEX F BX 7011 biodegradable plastic (1,4-butandiol, terephthalate, adipic acid copolymer) (BASF) and a second ester additive were prepared by combining INGEO 2002D polylactide resin (NatureWorks LLC) with 5 parts by weight per hundred parts by weight resin (phr) of ECOFLEX and 5 phr of a second ester additive as shown in Table 4. A polymer blend also was prepared by combining INGEO 2002D polylactide resin with 5 phr ECOFLEX. Properties of the blends are provided in Table 4.

TABLE 4

| | PLA Blend | | | | | | | | |
|---|---|---|---|---|---|---|---|---|---|
| | D1 | D2 | D3 | D4 | D5 | D6 | D7 | D8 | D9 |
| First Ester Additive | ECO- | ECO- | ECO- | ECO- | ECO- | ECO- | ECO- | ECO- | ECO- |
| (5 phr) | FLEX | FLEX | FLEX | FLEX | FLEX | FLEX | FLEX | FLEX | FLEX |
| Second Ester Additive | None | DIOA | DOA | DOS | DIOS | DOG | DIOG | DOSu | DiOSu |
| (5 Phr) | | | | | | | | | |

Melt Viscosity 31.5 RPM, 210° C.

| | | | | | | | | | |
|---|---|---|---|---|---|---|---|---|---|
| Maximum Torque, mg | 2500 | 2400 | 2400 | 2400 | 2400 | 2450 | 2400 | 2500 | 2200 |
| Melt Time, min. | 7.0 | 6.4 | 6.5 | 6.5 | 6.4 | 6.2 | 6 | 6 | 5.5 |
| Melt Temperature, ° C. | 210 | 210 | 210 | 210 | 209 | 209 | 209 | 207 | 209 |
| Melt Torque, mg | 132 | 184 | 180 | 78 | 61 | 71 | 86 | 100 | 66 |
| Totalized Energy, kJ | 4.5 | 5.9 | 5.9 | 3.5 | 3.2 | 3.6 | 3.4 | 4.3 | 2.2 |

DSC ASTM D3418-03 10° C./minute

| | | | | | | | | | |
|---|---|---|---|---|---|---|---|---|---|
| Tm, ° C. first heat data | — | 100.32 | 104.96 | 106.79 | 102.67 | 98.64 | 107.6 | 98.6 | 108.9 |
| Tc, ° C. second heat data | — | 144.76 | 143.2, 150.0 | 144.4, 151.4 | 144.5, 150.8 | 144.3 | 144.2, 150.6 | 143.7, 150.2 | 143.7, 150.6 |
| Tg, ° C. second heat data | — | 49 | 47.84 | 49.25 | 49.53 | 47.98 | 48.6 | 47.8 | 39.5, 50.5 |

Original Physical Properties

| | | | | | | | | | |
|---|---|---|---|---|---|---|---|---|---|
| Tensile Strength, MPa | 21.3 | 38.6 | 40.9 | 37.6 | 40.5 | 38.4 | 39.3 | 35.9 | 40.0 |
| psi | 3100 | 5595 | 5930 | 5460 | 5875 | 5575 | 5700 | 5210 | 5800 |
| Tensile at Break, MPa | 21.3 | 26.4 | 28.3 | 31.9 | 22.2 | 28.3 | 34.4 | 26.8 | 32.0 |
| psi | 3100 | 3825 | 4100 | 4630 | 3215 | 4110 | 4995 | 3890 | 4640 |
| Elongation @ Break, % | 0 | 26 | 40 | 24 | 64 | 22 | 13 | 18 | 13 |
| Hardness Duro D, pts. | 79 | 78 | 77 | 79 | 77 | 79 | 79 | 75 | 75 |
| Specific Gravity | — | 1.241 | 1.253 | 1.246 | 1.247 | 1.253 | 1.248 | 1.255 | 1.249 |

Gardner Impact Resistance, ASTM D5420

| | | | | | | | | | |
|---|---|---|---|---|---|---|---|---|---|
| in lbf | 4.4 | 8.7 | 7.1 | 7.9 | 10.5 | 9.6 | 7.6 | 7.3 | 5.0 |
| Joules | 0.5 | 1.0 | 0.8 | 0.9 | 1.2 | 1.1 | 0.9 | 0.8 | 0.6 |

Even at a lower ester loading level compared to Example 3, the polymer blends demonstrated improved Gardner impact resistance compared to both unmodified PLA, for which Gardner impact resistance of 1.6 in lbf (0.19 Joules) has been demonstrated (see, Tables 1 and 2), and PLA blended with a commercially available petroleum-based polymeric ester (blend D1). In particular, blends of PLA with a combination of 5 phr ECOFLEX and 5 phr of a second ester selected from di-2-ethylhexyl adipate, diisoctyl adipate, di-2-ethylhexyl sebacate, diisooctyl sebacate, di-2-ethylhexyl glutarate, diisooctyl glutarate, di-2-ethylhexyl succinate, and diisooctyl succinate (blends D2 to D9) demonstrated significant improvements in impact resistance compared to both unmodified PLA and PLA blended with ECOFLEX.

In addition, all ester blends D2 to D9 demonstrated reduced brittleness compared to unmodified PLA, as evidenced by both a reduction in Tg and an increase in elongation at break for blends D2 to D9. Furthermore, processing improvements were demonstrated for the blends, including a reduction in the energy required to masticate the PLA formulations and a reduction in processing temperature.

### Example 5

### Preparation of PLA-Ester Blends Including Two Impact Modifiers at 17 phr in Total

Polymer blends of polylactic acid (PLA) with BIOSTRENGTH 200 acrylic polymer (Arkema) and a second ester additive were prepared by combining INGEO 2002D polylactide resin (NatureWorks LLC) with 7 parts by weight per hundred parts by weight resin (phr) of BIOSTRENGTH and 10 phr of a second ester additive as shown in Table 5. A polymer blend also was prepared by combining INGEO 2002D polylactide resin with 7 phr BIOSTRENGTH. Properties of the blends are provided in Table 5.

TABLE 5

| PLA Blend | E1 | E2 | E3 | E4 |
|---|---|---|---|---|
| First Ester Additive (7 phr) | BIO- | BIO- | BIO- | BIO- |
| | STRENGTH | STRENGTH | STRENGTH | STRENGTH |
| Second Ester Additive (10 phr) | None | DNOS | DOS | DIOSu |

Melt Viscosity 31.5 RPM, 210° C.

| | | | | |
|---|---|---|---|---|
| Maximum Torque, mg | 2700 | 2250 | 2000 | 2000 |
| Melt Time, min. | 10 | 7.5 | 7.5 | 7.25 |
| Melt Temperature, ° C. | 211 | 209 | 209 | 207 |
| Melt Torque, mg | 55 | 50 | 67 | 15 |
| Totalized Energy, kJ | 5.6 | 4.4 | 3.6 | 3.9 |

DSC ASTM D3418-03 10° C./minute

| | | | | |
|---|---|---|---|---|
| Tm, ° C. first heat data | 119.8 | 102.6 | 101.6 | 96.3 |
| Tc, ° C. second heat data | — | — | — | — |
| Tg, ° C. second heat data | 58.5 | 51.2 | 49.1 | 47.5 |

Original Physical Properties

| | | | | |
|---|---|---|---|---|
| Tensile Strength, MPa | 38.3 | 22.1 | 27.7 | 25.5 |
| psi | 5560 | 3200 | 4015 | 3695 |
| Tensile at Break, MPa | 38.3 | 22.1 | 22.4 | 17.8 |
| psi | 5560 | 3200 | 3245 | 2580 |
| Elongation @ Break, % | 0 | 0 | 50 | 100 |
| Hardness Duro D, pts. | 72 | 75 | 75 | 72 |
| Specific Gravity | 1.244 | 1.234 | 1.240 | 1.242 |

Gardner Impact Resistance, ASTM D5420

| | | | | |
|---|---|---|---|---|
| in lbf | 8.0 | 13.5 | 12.8 | 8.5 |
| Joules | 0.9 | 1.5 | 1.4 | 1.0 |

The PLA-ester blends demonstrated improved Gardner impact resistance compared to both unmodified PLA, for which Gardner impact resistance of 1.6 in lbf (0.19 Joules) has been demonstrated (see, Tables 1 and 2), and PLA blended with BIOSTRENGTH acrylic polymer (blend E1). In particular, blends of PLA with a combination of 7 phr BIOSTRENGTH and 10 phr of a second ester selected from di-n-octyl sebacate, di-2-ethylhexyl sebacate, and diisooctyl succinate (blends E2 to E4) demonstrated significant improvements in impact resistance compared to both unmodified PLA and PLA blended with BIOSTRENGTH (blend E1).

Advantageously, when the ester blends are formed into films, all ester blends E2 to E4 are transparent, which is frequently a desired property for packaging and other materials. While a blend having only Biostrength (blend E1) as the ester additive is less opaque than blends having only Ecoflex as the ester additive, films formed from blends E2 to E4 are more transparent than blend E1. In addition, all ester blends E2 to E4 demonstrated reduced brittleness compared to unmodified PLA, as evidenced by a reduction in Tg for blends E2 to E4. Blends E3 and E4 also demonstrated reduced brittleness evidenced by an increase in elongation at break. Furthermore, processing improvements were demonstrated for the blends, including a reduction in the energy required to masticate the PLA formulations and a reduction in processing temperature.

While specific embodiments have been illustrated and described, numerous modifications come to mind without departing from the spirit of the invention and the scope of protection is only limited by the scope of the accompanying claims.

1. A polymer blend comprising
(i) a biopolymer and
(ii) one or more impact modifiers, wherein at least one impact modifier is an ester of formula I: 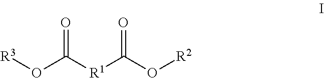
wherein R¹ is a substituted or unsubstituted aliphatic hydrocarbon group having 1 to 10 carbon atoms;
R² and R³ are each a substituted or unsubstituted aliphatic hydrocarbon group having 4 to 14 carbon atoms;
and the one or more impact modifiers are present in a total amount of about 5 to about 30 parts by weight per hundred parts by weight of the biopolymer.

2. The polymer blend of claim 1, wherein R¹ is a substituted or unsubstituted aliphatic hydrocarbon group having 2 to 8 carbon atoms.

3. The polymer blend of claim 1, wherein R¹ is selected from the group consisting of —(CH₂)₂— and —(CH₂)₈—.

4. The polymer blend of claim 1, wherein R² and R³ are each a substituted or unsubstituted aliphatic hydrocarbon group having 6 to 12 carbon atoms.

5. The polymer blend of claim 1, wherein R² and R³ are each a substituted or unsubstituted aliphatic hydrocarbon group having 8 to 10 carbon atoms.

6. The polymer blend of claim 1, wherein R² and R³ are each independently selected from the group consisting of n-octyl, isooctyl, and 2-ethylhexyl.

7. The polymer blend of claim 1, wherein R¹ is —(CH₂)₂—, and R² and R³ are selected from the group consisting of n-octyl, isooctyl, and 2-ethylhexyl.

8. The polymer blend of claim 1, wherein R¹ is —(CH₂)₈—, and R² and R³ are selected from the group consisting of n-octyl, isooctyl, and 2-ethylhexyl.

9. The polymer blend of claim 1, wherein the ester of formula I is selected from the group consisting of diisoctyl adipate, di-2-ethylhexyl adipate, diisooctyl sebacate, di-2-ethylhexyl sebacate, diisoctyl glutarate, di-2-ethylhexyl glutarate, diisooctyl succinate, di-2-ethylhexyl succinate, di-n-octyl sebacate, tributyl citrate, acetyl tributyl citrate, and tetraethylene glycol di-2-ethylhexoate.

10. The polymer blend of claim 1, wherein the impact modifiers are present in a total amount of about 5 to about 15 parts by weight per hundred parts by weight of the biopolymer.

11. The polymer blend of claim 1, wherein the biopolymer is selected from the group consisting of polylactic acid, polyhydroxybutyrate, polyvinyl alcohol, polybutylene succinate, polyhydroxyalkanoates, polycaprolactones, aliphatic-aromatic copolyesters, starches, celluloses, and mixtures thereof.

12. The polymer blend of claim 1, wherein the biopolymer is polylactic acid.

13. The polymer blend of claim 1, wherein the impact modifiers comprise two or more esters of formula I.

14. The polymer blend of claim 1 further comprising a second impact modifier selected from the group consisting of polyesters and acrylic polymers.

15. The polymer blend of claim 14, wherein the ester of formula I is present in an amount of about 5 to about 15 parts by weight per hundred parts by weight of the biopolymer and the polyester or acrylic polymer is present in an amount of about 5 to about 15 parts by weight per hundred parts by weight of the biopolymer.

16. The polymer blend of, claim 14 wherein the polyester comprises a copolymer of an aliphatic diol and an aliphatic diacid.

17. The polymer blend of claim 14, wherein the polyester comprises a copolymer of 1,2-propanediol, succinic acid, and decanol.

18. The polymer blend of claim 14, wherein the polyester comprises a copolymer of an aliphatic diol, an aromatic diacid, and an aliphatic diacid.

19. The polymer blend of claim 14, wherein the polyester comprises a copolymer of 1,4-butanediol, terephthalate, and adipate.

20. A method for increasing the impact resistance of a biopolymer comprising mixing a biopolymer and one or more impact modifiers, wherein at least one impact modifier is a ester of formula I: 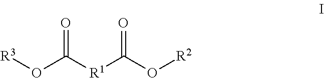
wherein R¹ is a substituted or unsubstituted aliphatic hydrocarbon group having 1 to 10 carbon atoms;
R² and R³ are each a substituted or unsubstituted aliphatic hydrocarbon group having 4 to 14 carbon atoms;
and the one or more impact modifiers are present in a total amount of about 5 to about 30 parts by weight per hundred parts by weight of the biopolymer.

21. The method of claim 20, wherein R¹ is —(CH₂)₂—, and R² and R³ are selected from the group consisting of n-octyl, isooctyl, and 2-ethylhexyl.

22. The method of claim 20, wherein R¹ is —(CH₂)₈—, and R² and R³ are selected from the group consisting of n-octyl, isooctyl, and 2-ethylhexyl.

23. The method of claim 20, further comprising a second impact modifier selected from the group consisting of polyesters and acrylic polymers.

24. A polymer blend comprising
(i) a biopolymer and
(ii) one or more impact modifiers, wherein at least one impact modifier is an ester of formula I: 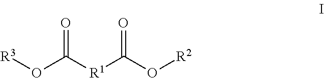
wherein R¹ is selected from the group consisting of —(CH₂)₂— and —(CH₂)₈—,
R² and R³ are selected from the group consisting of n-octyl, isooctyl, and 2-ethylhexyl;
and the impact modifiers are present in a total amount of about 5 to about 30 parts by weight per hundred parts by weight of the biopolymer.

25. The polymer blend of claim 24, wherein the impact modifiers are present in a total amount of about 5 to about 15 parts by weight per hundred parts by weight of the biopolymer.

26. The polymer blend of claim 24, wherein the biopolymer is polylactic acid.

27. The polymer blend of claim 24, wherein R¹ is —(CH₂)₂—, and R² and R³ are isooctyl.

28. The polymer blend of claim 24, wherein R¹ is —(CH₂)₈—, and R² and R³ are selected from the group consisting of isooctyl and n-octyl.

29. A polymer blend comprising
(i) a biopolymer and
(ii) two or more impact modifiers, wherein at least one impact modifier is a polyester comprising a copolymer of an aliphatic diol, an aromatic diacid, and an aliphatic diacid; and at least one impact modifier is an ester of formula I: 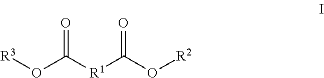
wherein R¹ is a substituted or unsubstituted aliphatic hydrocarbon group having 1 to 10 carbon atoms;
R² and R³ are each a substituted or unsubstituted aliphatic hydrocarbon group having 4 to 14 carbon atoms;
and the two or more impact modifiers are present in a total amount of about 5 to about 30 parts by weight per hundred parts by weight of the biopolymer.

30. The polymer blend of claim 29, wherein the polyester comprises a copolymer of 1,4-butanediol, terephthalate, and adipate.
